(19) United States
(12) Patent Application Publication
(10) Pub. No.: US 2010/0302024 A1
(43) Pub. Date: Dec. 2, 2010

(54) SIGNALLING DEVICE FOR THE TRUNK OR TOP CASE OF A TWO-WHEELED VEHICLE

(76) Inventor: Mohamed Ait El Hadj, Nice (FR)

Correspondence Address: VOLPE AND KOENIG, P.C., UNITED PLAZA, 30 SOUTH 17TH STREET, PHILADELPHIA, PA, 19103, US

(21) Appl. No.: 12/599,460

(22) PCT Filed: Apr. 25, 2008
(86) PCT No.: PCT/FR2008/000594

§ 371 Date: Nov. 9, 2009

(30) Foreign Application Priority Data
May 11, 2007 (FR) 0703362

(51) Int. Cl. B60Q 1/26; B60Q 1/44

(52) U.S. Cl. 340/479; 340/468

(57) ABSTRACT

A signalling device is provided that includes a transmitter to be connected to a circuit for controlling at least one primary signalling light or a specific control of the cycle and, on the other hand, a receiver connected to at least one secondary signalling light, said receiver being capable of receiving a signal emitted by said transmitter in order to control the switching on and/or off of the secondary signalling light synchronously with the switching on and/or off of the primary signalling light. The secondary signalling light is positioned on a holder to be rigidly mounted on the trunk or top case. The device can particularly be used for signalling applications for motorcycles and quads, and a simpler version can be achieved by suppressing the transmitter-receiver link and implementing a direct wire connection.

### FIELD OF INVENTION

The present invention relates to a signalling device which enables cycles, and in particular motorcycles, equipped with a trunk or top case, to be more easily seen by road users, in particular by motorists, for example, during changes of direction or braking operations.

### BACKGROUND

More particularly, the present invention relates to a signalling device comprising, on the one hand, a transmitter which is intended to be connected to at least one primary signalling light of a cycle and, on the other hand, a receiver which is connected to at least one secondary signalling light, said receiver being capable of receiving a signal transmitted by said transmitter so as to command the switching on and/or off of the secondary signalling light in synchronism with the switching on and/or off of the primary signalling light.

Changes of direction and braking operations are traditionally signalled by means of two indicator lights and one brake light which are positioned at the rear of motorcycles, at a height of approximately one metre. Such an arrangement of the indicator lights and of the brake light is not sufficient to effectively alert other road users, and in particular motorists. However, the safety of motorcyclists on the road depends on the visibility of said motorcyclists to other road users.

Certain devices already exist, such as reflective sashes or safety vests in bright colours, but these do not make the motorcyclist much more visible for all that. Moreover, these devices do not indicate the braking or changes of direction of the vehicle.

According to other devices of the prior art, a light signalling means, positioned on the helmet of a motorcyclist, indicates the braking of his vehicle. The light signal is controlled by a transmitter/receiver system. The transmitter is placed in the brake light or on the body at the rear of the seat of the motorcycle. It is connected to the brake light of the motorcycle and transmits an infrared signal to the receiver on the helmet.

These devices are ineffective in the presence of a passenger installed at the rear of the driver of the cycle. This is because, due to his presence at the rear of the driver, a passenger prevents, on the one hand, the transmission of the infrared signal from the transmitter to the receiver and, on the other hand, the visibility of the light signal to other road users.

Such devices moreover cannot be used by an occasional driver of the motorcycle, particularly if he is unable to borrow the helmet of the main driver. This is because the receiver and the light signal are fixed to the helmet by means of an adhesive, which cannot be unstuck and stuck back on again without impairing its adhesive properties.

In addition, the visibility of said light signal, to the other road users, is dependent on the orientation of the head of the person wearing the helmet, which makes the device ineffective when said wearer orients his head to the wrong side relative to said users.

Finally, according to another disadvantage of this prior art, only braking is indicated by this light signal on the helmet. Changes in direction are still indicated only by the original indicator lights on the motorcycle. It is not permitted to envisage additional light signals on the helmet of the motorcyclist, without dazzling the driver or the passenger of the cycle.

### SUMMARY

Considering what has been stated above, one problem that the invention proposes to solve is that of providing a signalling device, intended for a cycle equipped with a trunk or top case, which is capable of indicating the braking and/or changes in direction of the cycle in synchronism with the signalling lights of the cycle, and which does not have the disadvantages of the existing systems.

Another problem that the present invention proposes to solve is that of providing a signalling device, intended for a cycle, which is able to function in an optimal manner even in the presence of a passenger or even in the event of a change of driver.

The solution to these stated problems, as proposed by the invention, relates to a signalling device which comprises, on the one hand, a transmitter which is intended to be connected to at least one primary signalling light of a cycle and, on the other hand, a receiver which is connected to at least one secondary signalling light, said receiver being capable of receiving a signal transmitted by said transmitter so as to command the switching on and/or off of the secondary signalling light in synchronism with the switching on and/or off of the primary signalling light, characterised in that said secondary signalling light is positioned on a support which is intended to be placed removably on the trunk or top case.

Thus, the signalling device remains effective in the presence of a passenger, visible to other road users, particularly those following the cycle.

Advantageously,—the transmitter is connected to a control circuit of at least one primary signalling light of a cycle, and the receiver is connected to at least one secondary signalling light;—the transmitter is connected to the control circuit of the brake light and of the two indicator lights of the cycle, and the secondary signalling lights comprise a brake light and two indicator lights;—the signal transmitted by the transmitter is received by the receiver;—the transmitter is secured to the cycle;—the transmitter is positioned below the seat of the cycle; said support comprises a system for holding the secondary signalling light(s) and a system for fixing to the trunk or top case;—said support comprises an anti-impact protection and a sealed protection for the components;—said system for fixing the components comprises a shell and one or two points for rapid attachment via screws.

### BRIEF DESCRIPTION OF THE DRAWINGS

The invention will be better understood on reading the following non-limiting description and the accompanying drawings, in which:

FIG. 1 shows, in an exploded perspective view, one embodiment of a device according to the invention, which comprises a shell; and

FIG. 2 schematically shows the transmitter, connected to the control circuit of the primary signalling lights of a motorcycle, and the receiver, connected to the secondary signalling lights according to the invention.

### DETAILED DESCRIPTION OF THE PREFERRED EMBODIMENTS

The terms cycle, transmitter and receiver are defined as follows according to the present invention.

By cycle we mean any vehicle comprising one or more wheels, one or more signalling lights, referred to as primary signalling lights, and one or more control circuits of these primary signalling light(s). Preferably, the cycle comprises at least two wheels, such as for example a moped or motorcycle, which may or may not be accompanied by a sidecar.

By transmitter we mean any electronic device which is designed to transmit one or more signals to one or more receivers. Preferably, the transmitter comprises at least one oscillator, at least one microprocessor, at least one antenna intended for transmitting the signal, and at least one connection to the control circuit of the primary signalling lights on the cycle. Advantageously, it additionally comprises at least one shield for the printed circuits, which is intended to minimise interference, for example the interference generated by the cycle itself.

By receiver we mean any electronic device which is designed to receive the signal(s) transmitted by one or more transmitters. Preferably, the receiver comprises at least one microprocessor, at least one antenna intended for receiving the signal, at least one electrical power source, and at least one connection to the secondary signalling lights. Advantageously, it additionally comprises at least one shield for the various printed circuits, so that the only frequencies transmitted are those broadcast by the antenna and passing through the shield.

The transmitter of the device according to the invention can be connected to the control circuits of the primary signalling lights of the cycle.

The control circuit of a primary signalling light comprises, on the one hand, an electrical circuit which is intended to connect at least one primary signalling light to at least one electrical power source, such as the battery of the cycle for example, and, on the other hand, at least one switch which is intended to open and/or close the electrical power supply circuit of the primary signalling light.

The transmitter is advantageously of small size. It can thus be secured to the cycle, and it can easily be housed in the cycle, such as for example below the seat or in the rear red light of the cycle. In this way, it is protected for example against bad weather, external impacts or other types of attack, and does not impede the user in any way.

According to the present invention, the transmitter sends a signal to the receiver each time the control circuit of a primary signalling light is supplied with power, i.e. is closed. The receiver receives said signal and commands the switching-on of the corresponding secondary signalling light in synchronism with the switching-on of the primary signalling lights, and without having any effect on the brightness of the switched-on primary signalling light. The microprocessor of the transmitter is able to identify the control circuit of the signalling light which is or is not activated, and to transmit this information to the receiver. The microprocessor of the receiver analyses the received signal and activates, in response, the power supply circuit of the secondary signalling light corresponding to the activated primary light.

The electrical power source of the receiver is for example, and without any limitation, at least one battery, at least one accumulator or at least one capacitor. Advantageously, the source is rechargeable and may then comprise at least one accumulator and an output intended for the charging thereof. For example, the source comprises five accumulators, advantageously with a total voltage of 6 V. Different capacities can be used, each with a corresponding size and life span. The elements used may be of the AA or AAA type. Advantageously, a light-emitting diode indicates the charging of the electrical power source. A switch makes it possible to interrupt the power supply circuit of the receiver during charging of the electrical power source, so as to protect the components of the electronic circuit(s) of the receiver. When the transmitter is operating, the two poles of the electrical power source are disconnected from the charging output.

According to the present invention, the signal transmitted by the transmitter and received by the receiver is a high-frequency electromagnetic signal, that is to say having a frequency greater than 300 MHz. Preferably, according to the invention, the signal comprises a wave having a frequency of approximately 434 MHz, for example 433.92 MHz, or of 868 MHz. This is a signal with a low power (10 mW) and a local range not exceeding 15 m. The use of the high frequency ensures perfect synchronism between the transmitter and the receiver. When the motorcyclist presses on the controls, the secondary signalling lights operate at the same time as the corresponding primary signalling lights on the cycle.

The signal transmitted by the transmitter is encoded, preferably by means of a digital encoder, for example a microprocessor. Thanks to the encoding of the signal, the receiver recognises the provenance of the signal and processes only the signals transmitted by the transmitter of the same signalling system. In addition, the signal transmits an information item corresponding to the state of activation of the various primary signalling lights.

Each secondary signalling light is formed by a visual signal source, preferably a light signal, such as, for example, and without any limitation, one or more light bulbs or, preferably, one or more light-emitting diodes. Such light-emitting diodes are characterised by a low power consumption and a long life span. Preferably, according to the invention, a signalling light comprises five groups of two light-emitting diodes in series.

According to the invention, said secondary signalling light(s) are positioned on at least one support which is intended to be placed removably at the back of a user.

This support is a means enabling the signalling light to be held in the desired position, on the trunk or top case. Thus, the signalling device has an efficacy that is always optimal.

Thus, the device according to the invention has the advantage of not dazzling either the driver or the passenger of the cycle or third parties.

It also has the advantage of ensuring an optimum visibility of the light signals to the other road users, regardless of the position of the head of the motorcyclist.

The support comprises a sealed anti-impact protection for the components. Preferably, the receiver is located on the same support as the secondary signalling lights. The protection then protects the secondary signalling lights and the receiver and the connections connecting them, against water and impacts. The anti-impact protection may be formed by a shell in which the components are inserted. Preferably, the secondary signalling lights are protected by one or more lenses, referred to as an indicator light lens or brake light lens.

The removable support comprises at least one system for holding the secondary signalling light(s), and at least one fixing system associated with the holding system.

The fixing system comprises, for example, a screw and a rapid attachment system.

The fixing system may additionally comprise a shell which contains said system for holding the components and any associated protection systems. The shell, which is optionally opaque, may comprise orifices opposite the secondary signalling lights.

The rapid attachment system comprises any known fixing system, such as for example wing screws or else nuts.

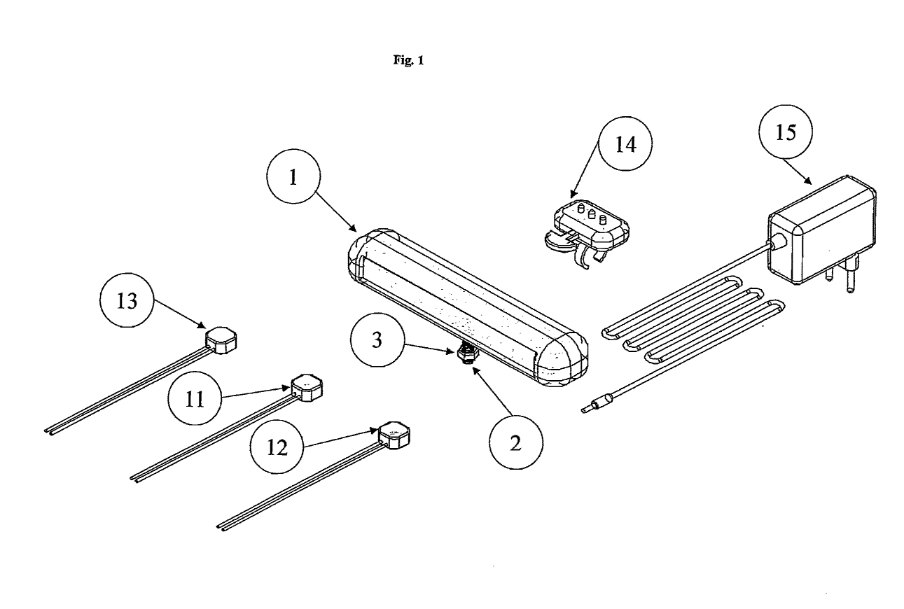

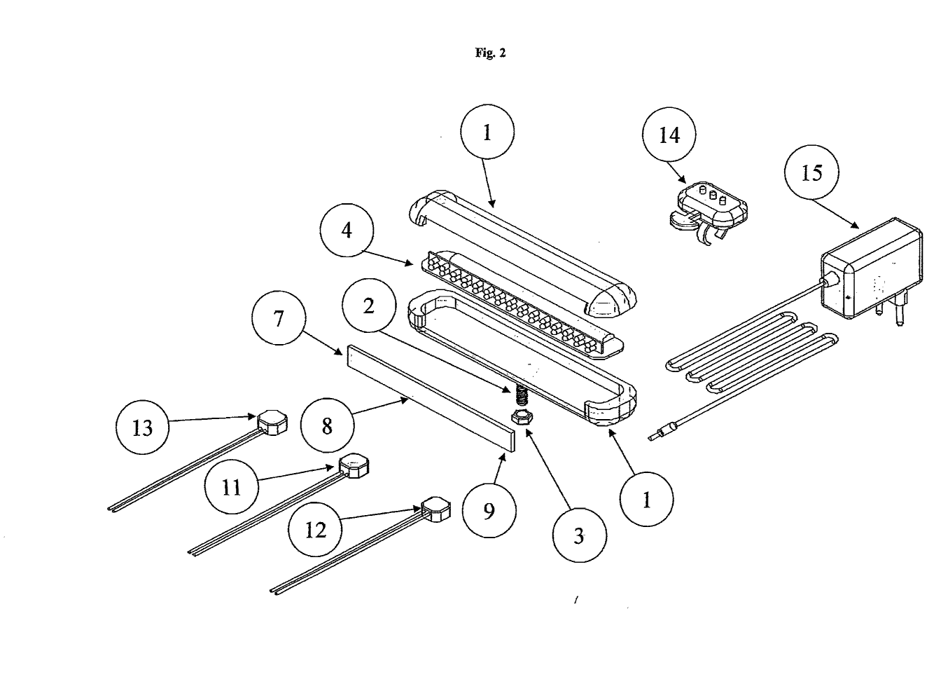

According to the embodiment shown in FIG. 1, the device according to the invention comprises a shell 1 which makes it possible for the user to attach it easily. The shell 1 comprises a lug 2 and a rapid attachment system 3. The shell 1 may be made from opaque material and/or from impermeable material.

A protective shell 1 has internal shapes in which there are housed a receiver 4, two secondary indicator signalling lights 6 and 7 and one secondary brake signalling light 5.

Orifices are formed in the shell 1 opposite the secondary signalling lights 5, 6 and 7. Indicator light lenses 9 and 10 and a brake light lens 8 are attached to the shell 1, opposite the orifices.

By way of non-limiting example, the shell 1 has dimensions of around 20 cm width, 5 cm depth and 3 cm thickness.

The transmitter 11, 12 or 13 comprises a housing of small size which contains the electronic components, and is placed in the cycle, below the seat.

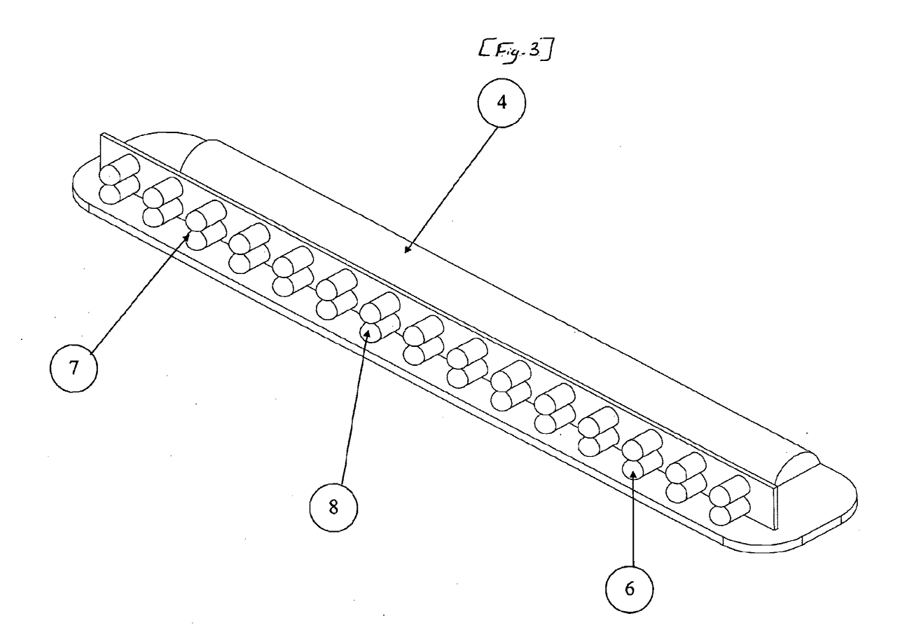

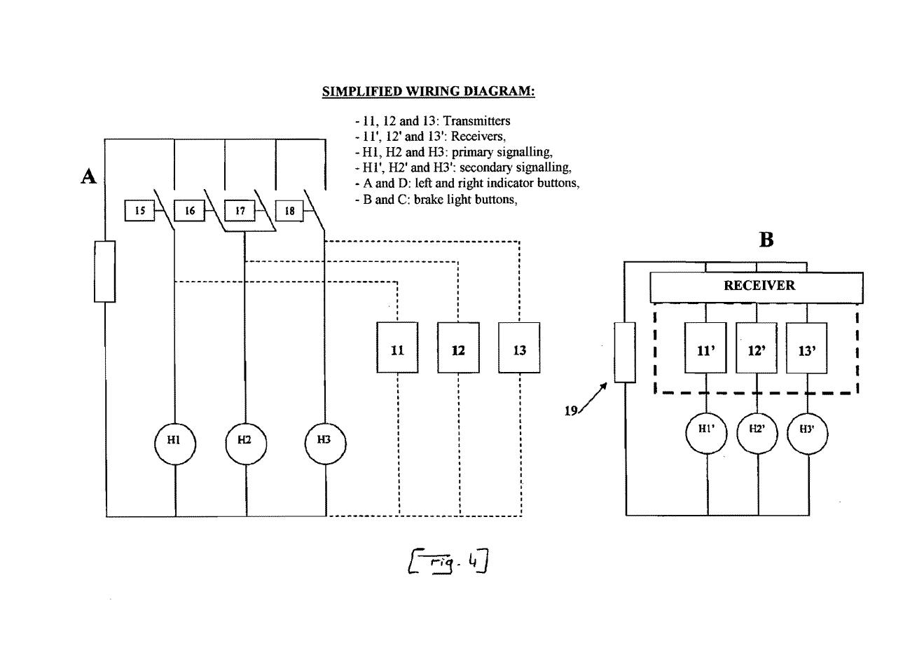

As shown in FIG. 2, the transmitters 11, 12 or 13 are connected to the control circuit 1 of the primary indicator signalling lights 15 and 16 and primary brake signalling light 14 on the cycle. The control circuit 18 of the primary signalling lights comprises, for each light, a bulb 19, 20 or 21 and one to two switches A, B, C or D, mounted in parallel on the battery 22 of the cycle. When one of the switches A, B, C or D is actuated by the driver of the cycle, it closes the corresponding parallel circuit, and the bulb 19, 20 or 21 is switched on. The control circuit of the brake light 21 comprises two switches B and C, which correspond to the brake command on the front wheel and to the brake command on the rear wheel of the cycle. The transmitter can be installed very quickly on the cycle.

The transmitter 16 is connected by electrical connectors to each of the aforementioned parallel circuits. It comprises a microprocessor 23 which analyses, at C1, C2 and C3, the information received from each of the aforementioned parallel circuits. The microprocessor 23 encodes, at C1, C2 and C3, the high-frequency signal that the transmitter 16 generates, in response, and that it transmits via the antenna 17.

The receiver 8 comprises a battery 24, comprising five accumulators of 1.2 V each, and an antenna (not shown). Said receiver is connected, by electrical connectors mounted in parallel, to the secondary signalling lights 9, 10 and 11. These signalling lights 9, 10 and 11 each comprise five groups of two light-emitting diodes mounted in series, so that such a light consumes on average 120 mA instead of the 250 mA normally required for ten light-emitting diodes mounted conventionally. The receiver 8 additionally comprises a microprocessor 25 which analyses the encoded high-frequency signal picked up by the antenna of the receiver and transmitted by the transmitter 16. The receiver 8 analyses this signal, at C1′, C2′ and C3′, and, in response, closes the circuits of the diodes 9, 10 and/or 11 corresponding to the switched-on primary lights 19, 20 and/or 21, and in synchronism.

According to another embodiment (not shown), the secondary signalling lights can also be switched on independently of any signal between the transmitter and the receiver. This mode of operation of the device can be used, for example, when the cycle is not travelling or when the cycle has no primary signalling lights.

1. A signalling device comprising, on the one hand, a transmitter, which is configured to be connected to at least one primary signalling light of a cycle and, on the other hand, a receiver, which is connected to at least one secondary signalling light, said receiver being capable of receiving a signal transmitted by said transmitter so as to command the switching on and/or off of the secondary signalling light in synchronism with the switching on and/or off of the at least one primary signalling light, wherein said at least one secondary signalling light is positioned on a support,. which is intended to be placed in a fixed position, and wherein if there is no existing primary signalling light, a specific command must be is added, and wherein the connection via transmitters/receivers can be replaced by a direct wire connection.

2. The device according to claim 1, wherein the transmitter is connected to a control circuit of at least one primary signalling light of a cycle, and wherein the receiver is connected to at least one secondary signalling light.

3. The device according to claim 1, wherein the transmitter is connected to the control circuit of the brake light and of the two indicator lights of the cycle, and wherein the at least one secondary signalling light comprises a brake light and two indicator lights.

4. The device according to claim 1, wherein the signal transmitted by the transmitter is received by the receiver.

5. The device according to claim 1, wherein the transmitter is secured to the cycle.

6. The device according to claim 5, wherein the transmitter is positioned below a seat of the cycle, or has a specific adaptable control.

7. The device according to claim 1, wherein said signal transmitted by the transmitter is encoded.

8. The device according to claim 1, wherein said support comprises a system for holding the at least one secondary signalling light and a system for fixing to a trunk or top case.

9. The device according to claim 1, wherein said support comprises an anti-impact protection and a sealed protection for the components.

10. The device according to claim 8, wherein said system for fixing the components comprises a shell, a fixing lug and a rapid attachment system.

11. The device according to claim 1, wherein the at least one secondary signalling light is placed in a fixed position on a trunk or top case.

12. The device according to claim 1, wherein the transmitter is not connected to a control circuit of at least one primary signalling light of a cycle, and wherein the receiver is connected to at least one secondary signalling light.

13. The device according to claim 1, wherein said signal transmitted by the transmitter is not encoded.
